(19) United States
(12) Patent Application Publication
(10) Pub. No.: US 2019/0377454 A1
(43) Pub. Date: Dec. 12, 2019

(54) TOUCH-SENSING DEVICE AND SENSING METHOD THEREOF

(71) Applicant: Shang-Li LEE, Keelung City (TW)

(72) Inventor: Shang-Li LEE, Keelung City (TW)

(21) Appl. No.: 16/430,589

(22) Filed: Jun. 4, 2019

(30) Foreign Application Priority Data
Jun. 7, 2018 (TW) 107119725

(51) Int. Cl. G06F 3/041; G06F 3/044

(52) U.S. Cl. CPC G06F 3/0418; G06F 3/04883; G06F 2203/04112; G06F 3/0446

(57) ABSTRACT

A sensing method of a touch-sensing device is provided, including: selecting one of a plurality of first electrodes as a background electrode; measuring a plurality of sensing points on the background electrode, to obtain a plurality of background signals; generating a touch-simulating signal that simulates a touch event; selecting another first electrode of the plurality of first electrodes as a selected electrode; measuring a plurality of sensing points on the selected electrode based on the plurality of background signals by using the touch-simulating signal, to obtain a plurality of simulation event signals; calculating a proportional relationship between the plurality of simulation event signals; and using the proportional relationship as a signal compensation coefficient of the plurality of sensing points on the selected electrode.

### CROSS-REFERENCE TO RELATED APPLICATION

This non-provisional application claims priority under 35 U.S.C. § 119(a) to Patent Application No. 107119725 in Taiwan, R.O.C. on Jun. 7, 2018, the entire contents of which are hereby incorporated by reference.

### BACKGROUND

### Technical Field

The present invention relates to a touch-sensing technology, and in particular, to a touch-sensing device and a sensing method thereof.

### Related Art

To improve use convenience, a growing quantity of electronic apparatuses use touch screens as operational interfaces, to allow a user to operate by directly touching a picture on a touch screen, thereby providing a more convenient and humanized operational mode. The touch screen mainly includes a display providing a displaying function and a touch-sensing device providing a touch function.

Generally, based on a sensing manner, the touch-sensing device may include a resistance-type touch-sensing device, a capacitive touch-sensing device, an induction-type touch-sensing device, an optical-type touch-sensing device, or the like. The capacitive touch-sensing device is used as an example. The capacitive sensing apparatus learns, by using a self-capacitance sensing technology and/or a mutual capacitance sensing technology, whether a panel is touched by a user. In a sensing process, when the capacitive sensing apparatus detects a change of a capacitance value at a coordinate location, the capacitive sensing apparatus determines that the coordinate location is touched by the user. Therefore, during running, the capacitive sensing apparatus stores a capacitance value without a touch for each coordinate location, and when subsequently receiving a latest capacitance value, determines, by comparing the latest capacitance value with the capacitance value without a touch, whether a location corresponding to the capacitance value is touched.

### SUMMARY

For a signal sensor of a touch-sensing device, basic signals for different locations are different, and in addition, induction strength for different locations is also different. This may cause erroneous determining of a touch.

In view of this, the present invention provides a touch-sensing device and a sensing method thereof, obtains and records an error of the induction strength for different locations by using a simulation signal of a touch event, and can perform induction strength compensation during normal running, thereby increasing accuracy of the touch-sensing device.

In an embodiment, a sensing method of a touch-sensing device is provided, including: selecting one of a plurality of first electrodes as a background electrode; measuring a plurality of sensing points on the background electrode, to obtain a plurality of background signals; generating a touch-simulating signal that simulates a touch event; selecting another first electrode of the plurality of first electrodes as a selected electrode; measuring a plurality of sensing points on the selected electrode based on the plurality of background signals by using the touch-simulating signal, to obtain a plurality of simulation event signals; calculating a proportional relationship between the plurality of simulation event signals; and using the proportional relationship as a signal compensation coefficient of the plurality of sensing points on the selected electrode.

In an embodiment, a sensing method of a touch-sensing device is provided, including: performing touch detection at the plurality of sensing points on the selected electrode, to generate a plurality of induction signals; adjusting the plurality of induction signals based on the signal compensation coefficient; and performing a determining procedure for the touch event based on each adjusted induction signal.

In an embodiment, a touch-sensing device is provided, including: a signal sensor, a signal simulation unit, and a signal processing circuit. The signal sensor includes: a plurality of first electrodes and a plurality of second electrodes that criss-cross each other. The signal simulation unit is configured to generate a touch-simulating signal that simulates a touch event. The signal processing circuit is electrically connected to the signal sensor. In addition, the signal processing circuit performs: selecting one of the plurality of first electrodes as a background electrode; measuring a plurality of sensing points on the background electrode, to obtain a plurality of background signals; selecting another first electrode of the plurality of first electrodes as a selected electrode; measuring a plurality of sensing points on the selected electrode based on the plurality of background signals by using the touch-simulating signal, to obtain a plurality of simulation event signals; calculating a proportional relationship between the plurality of simulation event signals; and using the proportional relationship as a signal compensation coefficient of the plurality of sensing points on the selected electrode. The background electrode and a plurality of second electrodes criss-cross to define the plurality of sensing points on the background electrode, and the selected electrode and the plurality of second electrodes criss-cross to define the plurality of sensing points on the selected electrode.

### BRIEF DESCRIPTION OF THE DRAWINGS

The present invention will become more fully understood from the detailed description given herein below for illustration only, and thus are not limitative of the present invention, and where:

FIG. 1 is a schematic block diagram of a touch-sensing device according to an embodiment of the present invention;

FIG. 2 is a schematic diagram of an embodiment of a signal sensor in FIG. 1;

FIG. 3 is a flowchart of an embodiment of a correction procedure for a sensing method of a touch-sensing device according to the present invention;

FIG. 4 is a flowchart of another embodiment of a correction procedure for a sensing method of a touch-sensing device according to the present invention;

FIG. 5 is a flowchart of still another embodiment of a correction procedure for a sensing method of a touch-sensing device according to the present invention;

FIG. 6 is a flowchart of yet another embodiment of a correction procedure for a sensing method of a touch-sensing device according to the present invention;

FIG. 7 is a flowchart of an embodiment of a normal procedure for a sensing method of a touch-sensing device according to the present invention;

FIG. 8 is a schematic diagram of an example of a signal simulation unit in FIG. 1;

FIG. 9 is a schematic diagram of another example of a signal simulation unit in FIG. I; and

FIG. 10 is a schematic diagram of still another example of a signal simulation unit in FIG. 1.

### DETAILED DESCRIPTION

First, a sensing method of a touch-sensing device according to any embodiment of the present invention is applicable to the touch-sensing device, such as but not limited to a touch panel, an electronic drawing board, or a handwriting board. In some embodiments, the touch-sensing device and a display may be integrated into a touch screen. In addition, a touch for the touch-sensing device may be generated by using a hand, or a touch component such as a touch pen or a painting brush.

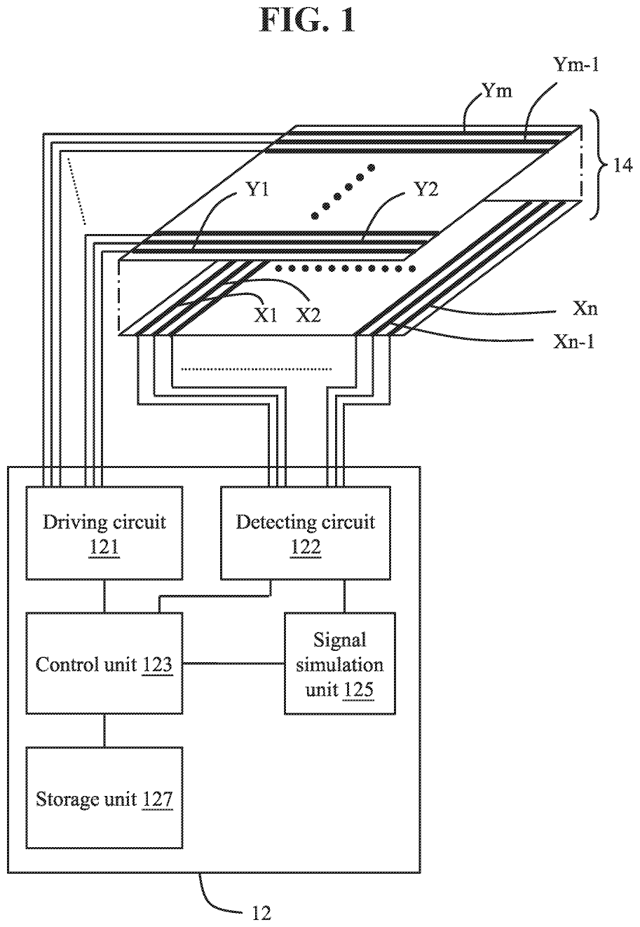

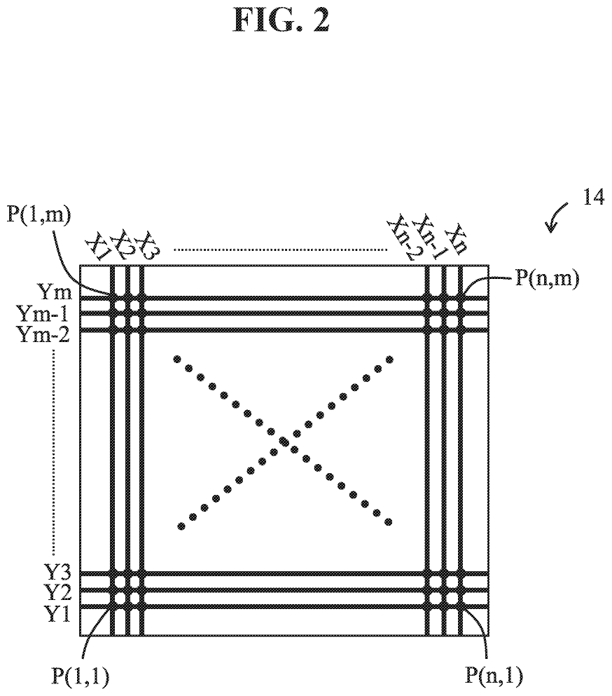

FIG. 1 is a schematic block diagram of a touch-sensing device according to an embodiment of the present invention. FIG. 2 is a schematic diagram of an embodiment of a signal sensor in FIG. 1. Referring to FIG. 1 and FIG. 2, the touch-sensing device includes a signal processing circuit 12 and a signal sensor 14. The signal sensor 14 is connected to the signal processing circuit 12.

In some embodiments, the signal sensor 14 includes a plurality of electrodes (for example, first electrodes X1 to Xn and second electrodes Y1 to Ym) that criss-cross each other. n and m are positive integers. n may be equal to m, or may be not equal to m. In a top view, the first electrodes X1 to Xn and the second electrodes Y1 to Ym criss-cross each other, and define a plurality of sensing points P(1,1) to P(n,m) disposed in a matrix, as shown in FIG. 2. In some embodiments, the first electrodes X1 to Xn and the second electrodes Y1 to Ym may be located on different planes (located on different sensing layers), and the different planes may sandwich but are not limited to sandwiching an insulation layer (not shown in the figure). In some other embodiments, the first electrodes X1 to Xn and the second electrodes Y1 to Ym may be located on a same plane, that is, located only on a single sensing layer.

In an embodiment, the first electrodes X1 to Xn may be driving electrodes, and the second electrodes Y1 to Ym may be induction electrodes. In another embodiment, the first electrodes X1 to Xn may be induction electrodes, and the second electrodes Y1 to Ym may be driving electrodes.

The signal processing circuit 12 includes a driving/detection unit and a control unit 123. The control unit 123 is coupled to the driving/detection unit. The driving/detection unit includes a driving circuit 121 and a detecting circuit 122. Herein, the driving circuit 121 and the detecting circuit 122 may be integrated into a single component, or may be implemented by using two components. This is determined based on a current status during design. The driving circuit 121 is configured to output a driving signal to the driving electrodes X1 to Xn, and the detecting circuit 122 is configured to measure the induction electrodes Y1 to Ym to obtain a measurement signal (such as a background signal or an induction signal) of each sensing point. Herein, the control unit 123 can be configured to: control running of the driving circuit 121 and the detecting circuit 122, and determine a change of a capacitance value for each sensing point based on the background signal (such as, the capacitance value sensed at the corresponding sensing point where no touch event has occurred) and the induction signal (such as, a capacitance value to be determined whether a touch event occurs at the corresponding sensing point or not). Herein, when the change of the capacitance value for the sensing point reaches an extent, the control unit 123 may determine that the corresponding sensing point is touched and determine, based on a determining result, whether to respond to a corresponding location signal.

In some embodiments, the signal processing circuit 12 may perform touch detection by using a self-capacitance detection technology, or a mutual capacitance detection technology. Using the self-capacitance detection technology as an example, when touch detection is performed, after the driving circuit 121 drives an electrode, the detecting circuit 122 may detect a self-capacitance value of the electrode, thereby detecting a change (relative to a corresponding background value) of the capacitance value. Herein, the detection of the self-capacitance value may be estimated by measuring a time spent on being charged to a voltage level (for example, by using a time to charge to set voltage (TCSV) method), or estimated by measuring a voltage value after charging lasts for a specified time (for example, by using a voltage after charging for a set time) method). Using the mutual capacitance detection technology as an example, when touch detection is performed, the driving/detection unit 121 selects a first electrode and a second electrode to drive, and then measures a mutual capacitance value between the selected first electrode and the selected second electrode, thereby detecting the change of the capacitance value. Herein, when it is measured that the change of the capacitance value reaches an extent, the control unit 123 may determine that a touch event occurs at the corresponding sensing point (that is, a touch component is touched) and determine, based on a determining result, whether to respond to a corresponding location signal.

Herein, the touch-sensing device can actively perform the sensing method of the touch-sensing device according to any embodiment of the present invention, thereby performing correction of the touch-sensing device at a proper moment to obtain a proper signal compensation coefficient, so that during an actual measurement (that is, a normal procedure), a measurement result of the touch-sensing device can be adjusted, and a. subsequent procedure (for example, threshold comparison, digital filtering, or signal magnification) for determining a touch event can be performed after the adjustment.

Further referring to FIG. 1, the signal processing circuit 12 may further include a signal simulation unit 125 and a storage unit 127. The control unit 123 is coupled to the storage unit 127. The signal simulation unit 125 is electrically connected between the driving circuit 121, the detecting circuit 122, and the control unit 123. The control unit 123 can control running of each component. Under the control of the control unit 123, the touch-sensing device selectively performs a normal procedure and a correction procedure.

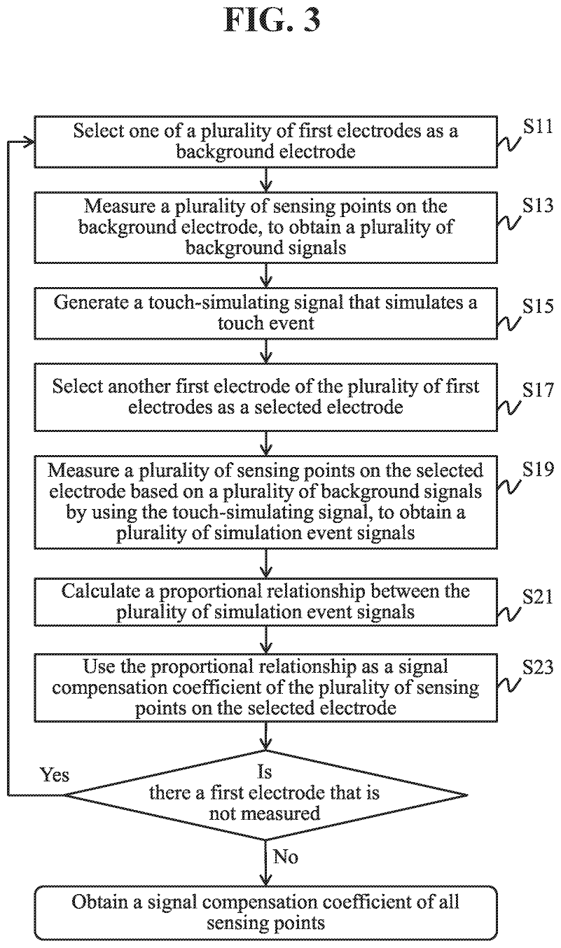

Referring to FIG. 1 to FIG. 3, in an embodiment of the correction procedure, the detecting circuit 122 selects one of the plurality of first electrodes X1 to Xn (such as a first electrode Xa) as a background electrode (step S11), and successively measures a plurality of sensing points P(Xa,Y1) to P(Xa,Ym) on the background electrode when the driving circuit 121 successively drives the second electrodes Y1 to Ym, to obtain background signals for the sensing points P(Xa,Y1) to P(Xa,Ym) (step S13).

Next, the signal simulation unit 125 generates a touch-simulating signal that simulates a touch event (step S15). That is, the touch-simulating signal is equivalent to signal strength generated by the touch event. In an embodiment, running of the signal simulation unit 125 may be implemented by establishing a gauge-type software/hardware in the signal processing circuit 12.

In this case, the detecting circuit 122 selects another first electrode (such as a first electrode Xb) of the first electrodes X1 to Xn as a selected electrode (step S17). In addition, the signal processing circuit 12 measures a plurality of sensing points P(Xb,Y1) to P(Xb,Ym) on the selected electrode based on a plurality of background signals by using the touch-simulating signal, to obtain a plurality of simulation event signals (step S19). In some examples of step S19, the detecting circuit 122 measures the plurality of sensing points P(Xb,Y1) to P(Xb,Ym) on the selected electrode by using the touch-simulating signal, to obtain touch induction signals (such as, a capacitance value sensed at the corresponding sensing point where no touch event has occurred) for the plurality of sensing points P(X1),Y1) to P(Xb,Ym), and then the control unit 123 subtracts, from the touch induction signals that are for the sensing points P(Xb,Y1) to P(Xb,Ym) and that are currently read by the detecting circuit 122, the background signals that are for the corresponding sensing points P(Xa,Y1) to P(Xa,Ym) and that are previously read, to obtain simulation event signals of the sensing points. The a is not equal to b, and a and b are respectively any two of 1 to n. For example, the signal processing circuit 12 first selects the first electrode Xa to obtain background signals of n sensing points P(Xa,Y1) to P(Xa,Ym) on the first electrode Xa. Then, the signal processing circuit 12 reselects the first electrode Xb, and enables the signal simulation unit 125. Next, the signal processing circuit 12 measures the sensing point P(Xb,Y1) on the first electrode Xb based on the background signal for the sensing point P(Xa,Y1) by using the touch-simulating signal, to obtain a simulation event signal for the sensing point P(Xb,Y1). After obtaining the simulation event signal for the sensing point P(Xb,Y1), the signal processing circuit 12 measures the sensing point P(Xb,Y2) on the first electrode Xb based on the background signal for the sensing point P(Xa,Y2) by using the touch-simulating signal, to obtain a simulation event signal for the sensing point P(Xb,Y2). After obtaining the simulation event signal for the sensing point P(Xb,Y2), the signal processing circuit 12 measures the sensing point P(Xb,Y3) on the first electrode Xb based on the background signal for the sensing point P(Xa,Y3) by using the touch-simulating signal, to obtain a simulation event signal for the sensing point P(Xb,Y3). The rest is deduced by analogy, until the signal processing circuit 12 obtains simulation event signals for all the sensing points P(Xb,Y1) to P(Xb,Ym) on the first electrode Xb.

Next, the control unit 123 calculates a proportional relationship between the plurality of simulation event signals (step S21). In an embodiment of step S21, the control unit 123 specifies one (such as a simulation event signal for a sensing point P(Xb,Y5)) of the plurality of simulation event signals of the plurality of sensing points P(Xb,Y1) to P(Xb,Ym) as 1, and then calculates ratios of other simulation event signals (such as simulation event signals for sensing points P(Xb,Y1) to P(Xb,Y4) and sensing points P(Xb,Y6) to P(Xb,Ym)) to the specified simulation event signal (such as the simulation event signal for the sensing point P(Xb,Y5)). In another embodiment of step S21, the control unit 123 specifies an average value (such as a simulation event signal for a sensing point P(Xb,Y5)) of the plurality of simulation event signals of the plurality of sensing points P(Xb,Y1) to P(Xb,Ym) as 1, and then calculates ratios of simulation event signals (such as simulation event signals for sensing points P(Xb,Y1) to P(Xb,Y4) and sensing points P(Xb,Y6) to P(Xb,Ym)) for the plurality of sensing points P(Xb,Y1) to P(Xb,Ym) to the average value.

In addition, the control unit 123 uses the calculated proportional relationship as a signal compensation coefficient of the plurality of sensing points P(Xb,Y1) to P(Xb,Ym) on the selected electrode Xb (step S23). Herein, the control unit 123 stores the calculated proportional relationship as the signal compensation coefficient in the storage unit 127.

Then, the signal processing circuit 12 repeatedly performs steps S11 to S23, to obtain signal compensation coefficients of a plurality of sensing points P(X1,Y1) to P(Xn,Ym) for all the first electrodes X1 to Xn. That is, in step S17, another first electrode for which a simulation event signal is not measured is reselected as the selected electrode. In this way, the signal processing circuit 12 can obtain the signal compensation coefficients of a complete panel (the plurality of sensing points P(X1,Y1) to P(Xn,Ym) for all the first electrodes X1 to Xn).

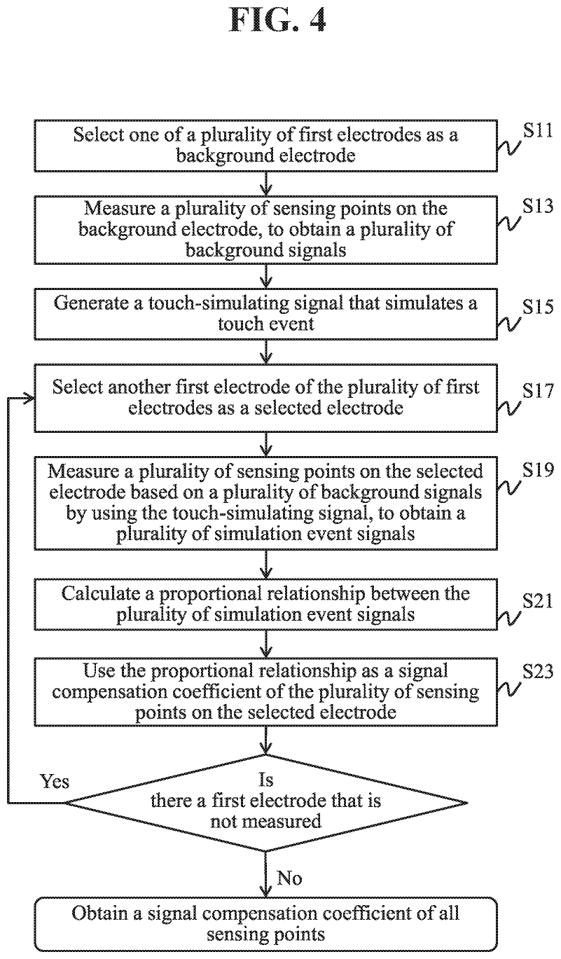

In another embodiment of the correction procedure, referring to FIG. 1, FIG. 2, and FIG. 4, after steps S11 to S23 are performed once, the signal processing circuit 12 may reselect another first electrode (such as Xc) as a selected electrode (that is, perform step S17 again), and continue to perform subsequent steps S19 to S23, to obtain signal compensation coefficients of a plurality of sensing points P(Xc,Y1) to P(Xc,Ym) on the next first electrode Xc. In addition, the signal processing circuit 12 repeatedly performs steps S17 to S23, to obtain the signal compensation coefficients of the plurality of sensing points P(X1,Y1) to P(Xn,Ym) for all the first electrodes X1 to Xn. In an example, selection and setting of a background electrode and a selected electrode may be not limited (the background electrode and the selected electrode may be the same first electrode, or may be different two first electrodes). In another example, selection and setting of a background electrode and a selected electrode may be limited to different first electrodes. If the selection and setting of the background electrode and the selected electrode are limited to the different first electrodes, the signal processing circuit 12 may select a first electrode Xa, located in an invalid area or an edge, as the background electrode, or after the signal processing circuit 12 repeatedly performs steps S17 to S23 to obtain a signal compensation coefficient corresponding to a first electrode other than the first electrode Xa, the signal processing circuit 12 further repeatedly performs steps S11 to S23 to obtain the signal compensation coefficient corresponding to the first electrode Xa. In this way, the signal processing circuit 12 can obtain the signal compensation coefficients of a complete panel (the plurality of sensing points P(X1,Y1) to P(Xn,Ym) for all the first electrodes X1 to Xn).

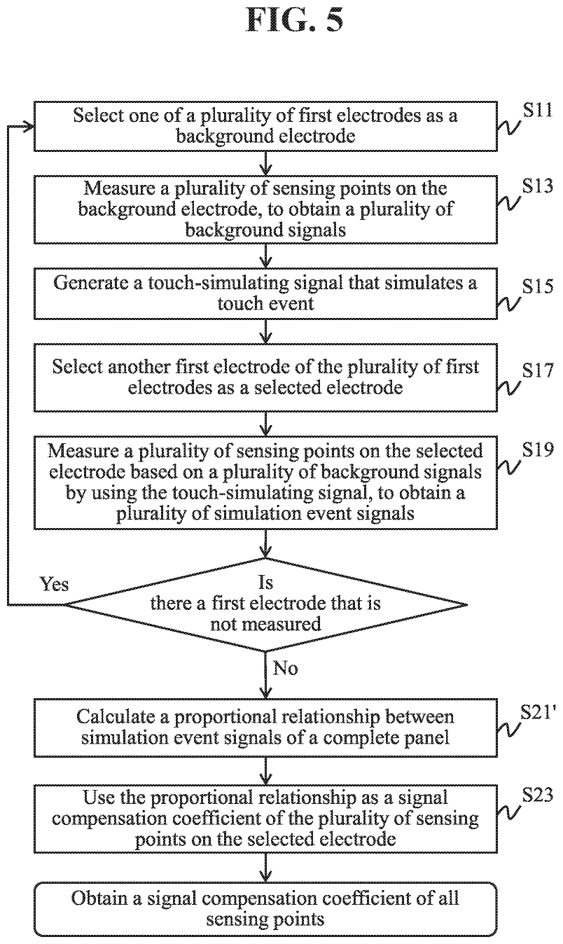

In still another embodiment of the correction procedure, referring to FIG. 1, FIG. 2, and FIG. 5, the signal processing circuit 12 may first repeatedly perform steps S11 to S19 to obtain a plurality of simulation event signals for the plurality of sensing points P(X1,Y1) to P(Xn,Ym) on all the first electrodes X1 to Xn. Then, the control unit 123 calculates a proportional relationship between the simulation event signals for all the sensing points P(X1,Y1) to P(Xn,Ym) (step S21′), and uses the calculated proportional relationship as the signal compensation coefficient (step S23).

In an embodiment of step S21″, the control unit 123 specifies one (such as a simulation event signal for a sensing point P(Xb,Y5)) of the simulation event signals of all the sensing points P(X1,Y1) to P(Xn,Ym) as 1, and then calculates ratios of other simulation event signals (such as simulation event signals for sensing points P(X1,Y1) to P(Xb,Y4) and sensing points P(Xb,Y6) to P(Xn,Ym)) to the specified simulation event signal (such as the simulation event signal for the sensing point P(Xb,Y5)). In another embodiment of step S21′, the control unit 123 specifies an average value of the simulation event signals for all the sensing points P(X1,Y1) to P(Xn,Ym) as 1, and then calculates ratios of the simulation event signals for all the sensing points P(X1,Y1) to P(Xn,Ym) to the average value.

The signal processing circuit 12 may repeatedly perform steps S11 to S19 to obtain the signal compensation coefficient of the first electrode Xa, or may select a first electrode Xa, located in an invalid area or an edge, as the background electrode. In this way, the signal processing circuit 12 can obtain the signal compensation coefficients of a complete panel (the plurality of sensing points P(X1,Y1) to P(Xn,Ym) for all the first electrodes X1 to Xn). In this way, the signal processing circuit 12 can obtain the signal compensation coefficients of a complete panel (the plurality of sensing points P(X1,Y1) to P(Xn,Ym) for all the first electrodes X1 to Xn), and the signal compensation coefficient has a single reference point.

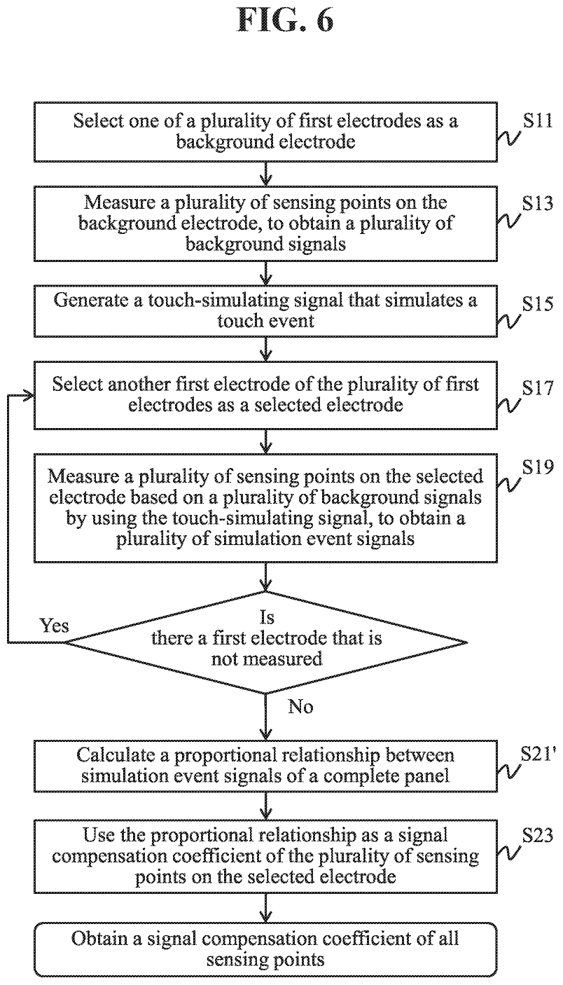

In yet another embodiment of the correction procedure, referring to FIG. 1, FIG. 2, and FIG. 6, after the signal processing circuit 12 performs steps S11 to S19 once, the signal processing circuit 12 may further repeatedly perform steps S17 to S19 to obtain a plurality of simulation event signals for the plurality of sensing points P(X1,Y1) to P(Xn,Ym) on all the first electrodes X1 to Xa−1 and Xa+1 to Xn. In an example, selection and setting of a background electrode and a selected electrode may be not limited. In another example, selection and setting of a background electrode and a selected electrode may be limited to different first electrodes. If the selection and setting of the background electrode and the selected electrode are limited to the different first electrodes, the signal processing circuit 12 may select a first electrode Xa, located in an invalid area or an edge, as the background electrode, or after the signal processing circuit 12 repeatedly performs steps S17 to S19 to obtain a signal compensation coefficient corresponding to a first electrode other than the first electrode Xa, the signal processing circuit 12 further repeatedly performs steps S11 to S19 to obtain the signal compensation coefficient corresponding to the first electrode Xa.

Then, the control unit 123 calculates a proportional relationship between the simulation event signals for all the sensing points P(X1,Y1) to P(Xn,Ym) (step S21′), and uses the calculated proportional relationship as the signal compensation coefficient (step S23). In this way, the signal processing circuit 12 can obtain the signal compensation coefficients of a complete panel (the plurality of sensing points P(X1,Y1) to P(Xn,Ym) for all the first electrodes X1 to Xn), and the signal compensation coefficient has a single reference point.

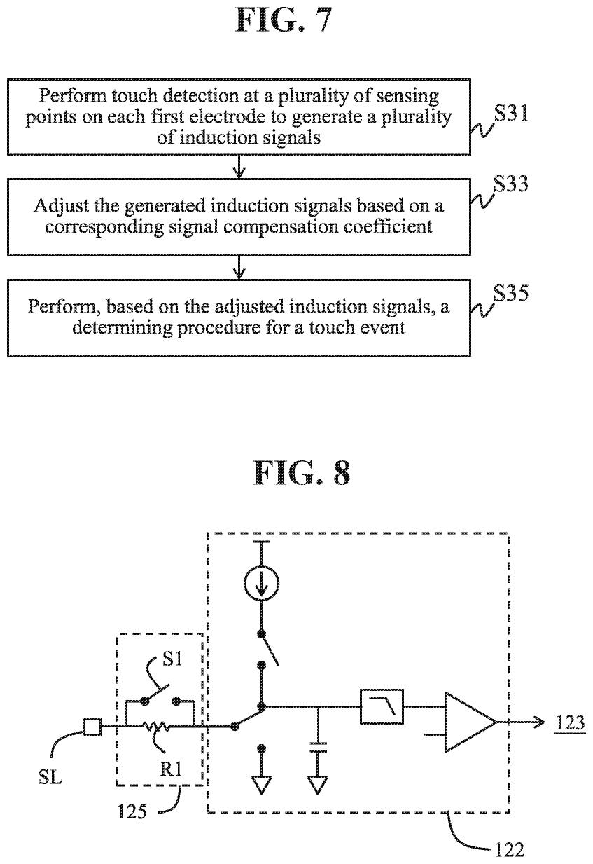

During the normal procedure, the signal processing circuit 12 disables the signal simulation unit 125. The normal procedure includes a detection procedure and a determining procedure. Referring to FIG. 7, during the determining procedure, the signal processing circuit 12 performs touch detection at a plurality of sensing points on each first electrode to generate a plurality of induction signals (step S31), and then first adjusts the generated induction signals based on a corresponding signal compensation coefficient (step S33). After the adjustment, the signal processing circuit 12 further performs, based on the adjusted induction signals, a determining procedure for a touch event (step S35).

For example, the detecting circuit 122 measures the plurality of sensing points P(Xb,Y1) to P(Xb,Ym) on the selected electrode by using the touch-simulating signal, to obtain the induction signals for the sensing points P(Xb,Y1) to P(Xb,Ym) (step S31). Next, the control unit 123 adjusts the induction signals based on individual corresponding ratios (such as 0.8, 0.7, . . . , 1, . . . , and 0.6) for the sensing points P(Xb,Y1) to P(Xb,Ym) in the signal compensation coefficient (step S33), and then performs subsequent signal processing (for example, threshold comparison, digital filtering, or signal magnification) by using the adjusted induction signals (step S35).

It should be understood that, a sequence of performing the steps is not limited to the sequence described above, and may be properly adjusted based on content performed in a step.

In some embodiments, the signal simulation unit 125 can be implemented by using a software or hardware circuit. In an example, the signal simulation unit 125 may be an impedance switch circuit that simulates the signal sensor 14, and may switch on or switch off (cross) a series resistor in the signal simulation unit 125 to simulate a case in which a touch event occurs or does not occur.

For example, referring to FIG. 8, the signal simulation unit 125 may include one or more combinations of a switch S1 and a resistor R1. Herein, a switched-capacitor circuit is used as an example for the detecting circuit 122. An input of the detecting circuit 122 is coupled to an induction electrode SL by using the resistor R1, and the switch S1 is coupled to two ends of the corresponding resistor R1.

In the normal procedure, each switch S1 switches on the two ends of the resistor R1, and the detecting circuit 122 directly measures an induction capacitor of the induction electrode SL for a driving electrode, and outputs a measurement value to the control unit 123. In the correction procedure, the switch S1 is open, so that the resistor R1 is connected to an input signal of the detecting circuit 122. In this case, the measurement value (a background signal for a sensing point P(j,i)) that is of the induction capacitor of the induction electrode SL for the driving electrode and that is measured by the detecting circuit 122 generates a corresponding voltage drop (a touch-simulating signal) by using the resistor R1, to form a touch induction signal, and then the touch induction signal is output to the control unit 123.

In some embodiments, when the signal simulation unit 125 has a plurality of combinations of a switch S1 and a resistor R1, the switches S1 control a quantity of coupled resistors R1 to provide touch-simulating signals with corresponding different capacitance values, that is, different resistance values represent signal responses of touches caused by different touch components (for example, a finger, water, and foreign matter). In some embodiments, when the signal simulation unit 125 has a single combination of a switch S1 and a resistor R1, the resistor R1 may be a variable resistor, and the control unit 123 may regulate a resistance value of the variable resistor, so that the resistor R1 provides a signal response that represents a touch (a touch event) caused by a touch component (such as a finger).

In another example, the signal simulation unit 125 may be a switched-capacitor circuit that simulates the signal sensor 14, and may switch on or switch off a series resistor in the signal simulation unit 125 to simulate a case in which a touch event occurs or does not occur.

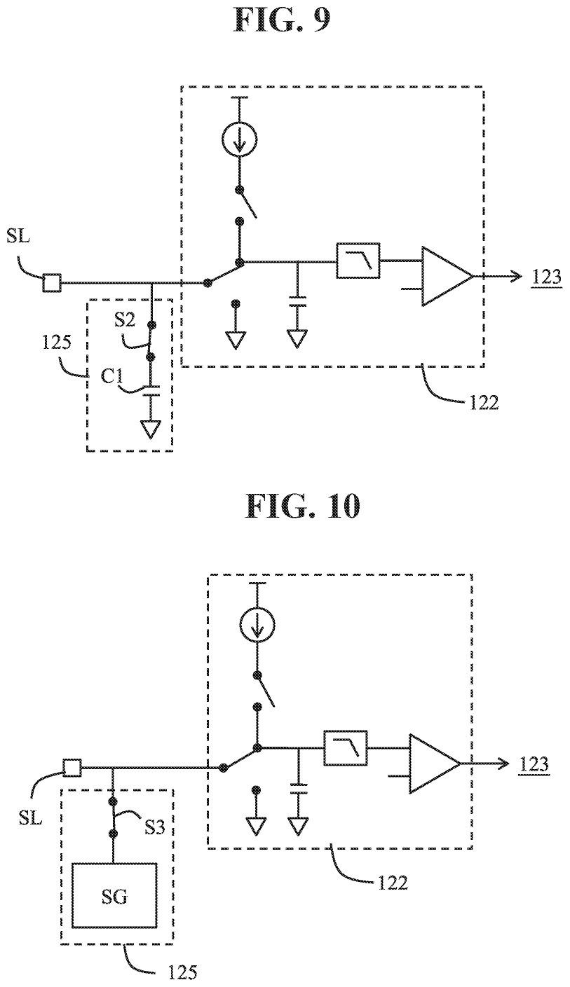

For example, referring to FIG. 9, the signal simulation unit 125 may include one or more combinations of a switch S2 and a resistor C1. Herein, a switched-capacitor circuit is used as an example for the detecting circuit 122. An input of the detecting circuit 122 is coupled to the induction electrode SL, and a capacitor C1 is coupled to the input of the detecting circuit 122 by using a corresponding switch S2. That is, when the switch S2 is switched on, the variable capacitor C1 is connected in parallel to the induction capacitor of the induction electrode SL for the driving electrode.

During the normal procedure, the switch S2 is switched off, and the detecting circuit 122 directly measures a capacitance value (a sensing signal) of the induction capacitor of the induction electrode SL for the driving electrode, and outputs the capacitance value to the control unit 123. During the correction procedure, the switch S2 is switched on, so that the capacitor C1 is connected in parallel to the induction capacitor of the induction electrode SL for the driving electrode. After the detecting circuit 122 measures a sum (a touch induction signal) of the capacitance value (a background signal) of the induction capacitor of the induction electrode SL for the driving electrode and the capacitance value (a touch-simulating signal) of the capacitor C1, the detecting circuit 122 further outputs the sum to the control unit 123.

In some embodiments, when the signal simulation unit 125 has a plurality of combinations of a switch S2 and a capacitor C1, the switches S2 control a quantity of parallel capacitors C1 to provide touch-simulating signals with corresponding different capacitance values, that is, the different capacitance values represent touch induction signals of touches caused by different touch components (for example, a finger, water, and foreign matter). In some embodiments, when the signal simulation unit 125 has a single combination of a switch S2 and a capacitor C1, the capacitor C1 may be a variable capacitor, and the control unit 123 may regulate a capacitance value of the variable capacitor, so that the capacitor C1 provides a signal response that represents a touch (a touch event) caused by a touch component (such as a finger).

In still another example, referring to FIG. 10, the signal simulation unit 125 may be a signal generator SG, and the signal generator SG is coupled to the input of the detecting circuit 122 by using a switch S3.

During the normal procedure, the switch S3 is switched off. During the correction procedure, the switch S3 is switched on, the signal generator SG may generate a required touch-simulating signal in a software form under the control of the control unit 123, and the detecting circuit 122 measures a sum (a touch induction signal) of a touch-simulating signal and the capacitance value (a background signal) of the induction capacitor of the induction electrode SL for the driving electrode, and then outputs the sum to the control unit 123.

In some embodiments, the signal simulation unit 125 is built in a wafer of a capacitive sensing apparatus and is isolated from an external environment of the capacitive sensing apparatus. That is, compared with the signal sensor 14, the signal simulation unit 125 is internally encapsulated and cannot be touched or approached (enough to affect an electric property of the signal simulation unit 125) by a finger, and therefore is not easily interfered by an external noise. The wafer in which the signal simulation unit 125 is built may be an independent wafer that does not implement other components (a control unit and a driving/detection unit), or a multi-purpose wafer that implements both the signal simulation unit 125 and other components (a control unit and a driving/detection unit or any combination of the control unit and the driving/detection unit). That is, the signal processing circuit 12 may be implemented by using one or more wafers. In some embodiments, the storage unit 127 may be further configured to store a related software/firmware program, a material, and data, a combination of the related software/firmware program, the material, and the data, and the like. Herein, the storage unit 127 may be implemented by using one or more memories.

In conclusion, the touch-sensing device and the sensing method thereof according to the present invention are applicable to the touch-sensing device. The touch-sensing device obtains and records an error of the induction strength for different locations by using a simulation signal of a touch event, and can perform induction strength compensation during normal running, thereby increasing accuracy of the touch-sensing device.

What is claimed is:

1. A sensing method of a touch-sensing device, comprising:
selecting one of a plurality of first electrodes as a background electrode;
measuring a plurality of sensing points on the background electrode, to obtain a plurality of background signals;
generating a touch-simulating signal that simulates a touch event;
selecting another first electrode of the plurality of first electrodes as a selected electrode;
measuring a plurality of sensing points on the selected electrode based on the plurality of background signals by using the touch-simulating signal, to obtain a plurality of simulation event signals;
calculating a proportional relationship between the plurality of simulation event signals; and
using the proportional relationship as a signal compensation coefficient of the plurality of sensing points on the selected electrode.

2. The sensing method of the touch-sensing device according to claim 1, further comprising:
performing touch detection at the plurality of sensing points on the selected electrode, to generate a plurality of induction signals;
adjusting the plurality of induction signals based on the signal compensation coefficient, and
performing a determining procedure for the touch event based on each adjusted induction signal.

3. The sensing method of the touch-sensing device according to claim 1, further comprising:
performing touch detection at the plurality of sensing points on the selected electrode, to generate a plurality of induction signals;
adjusting the plurality of induction signals based on the signal compensation coefficient; and
comparing each adjusted induction signal with a threshold, to determine whether the touch event occurs at the corresponding sensing point.

4. The sensing method of the touch-sensing device according to claim 1, wherein the step of calculating the proportional relationship between the plurality of simulation event signals for the plurality of sensing points comprises:
specifying one of the plurality of simulation event signals for the plurality of sensing points as 1; and
calculating a ratio of another simulation event signal of the plurality of simulation event signals to the specified simulation event signal.

5. The sensing method of the touch-sensing device according to claim 1, wherein the step of calculating the proportional relationship between the plurality of simulation event signals for the plurality of sensing points comprises:
specifying an average value of the plurality of simulation event signals for the plurality of sensing points as 1; and
calculating ratios of the plurality of simulation event signals to the average value.

6. The sensing method of the touch-sensing device according to claim 1, wherein the background electrode and a plurality of second electrodes criss-cross to define the plurality of sensing points on the background electrode, and the selected electrode and the plurality of second electrodes criss-cross to define the plurality of sensing points on the selected electrode.

7. The sensing method of the touch-sensing device according to claim 1, wherein the plurality of first electrodes are a plurality of induction electrodes.

8. The sensing method of the touch-sensing device according to claim 1, wherein the plurality of first electrodes are a plurality of driving electrodes.

9. A sensing method of a touch-sensing device, comprising:
performing touch detection at the plurality of sensing points on the selected electrode, to generate a plurality of induction signals;
adjusting the plurality of induction signals based on the signal compensation coefficient; and
performing a determining procedure for the touch event based on each adjusted induction signal.

10. The sensing method of the touch-sensing device according to claim 9, wherein the signal compensation coefficient is a proportional relationship between a plurality of simulation event signals on the selected electrode.

11. A touch-sensing device, comprising:
a signal sensor, comprising: a plurality of first electrodes and a plurality of second electrodes that criss-cross each other;
a signal simulation unit, generating a touch-simulating signal that simulates a touch event; and
a signal processing circuit, electrically connected to the signal sensor, wherein the signal processing circuit performs:
selecting one of the plurality of first electrodes as a background electrode;
measuring a plurality of sensing points on the background electrode, to obtain a plurality of background signals, wherein the background electrode and the plurality of second electrodes criss-cross to define the plurality of sensing points on the background electrode;
selecting another first electrode of the plurality of first electrodes as a selected electrode;
measuring a plurality of sensing points on the selected electrode based on the plurality of background signals by using the touch-simulating signal, to obtain a plurality of simulation event signals, wherein the selected electrode and the plurality of second electrodes criss-cross to define the plurality of sensing points on the selected electrode;
calculating a proportional relationship between the plurality of simulation event signals; and
using the proportional relationship as a signal compensation coefficient of the plurality of sensing points on the selected electrode.
